(19) United States
(12) Patent Application Publication
(10) Pub. No.: US 2010/0277359 A1
(43) Pub. Date: Nov. 4, 2010

(54) Vehicle radar apparatus having variable output power controlled based on speed of vehicle

(75) Inventor: Takamasa Ando, Gifu-shi (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/799,720

(22) Filed: May 1, 2010

(30) Foreign Application Priority Data
May 1, 2009 (JP) 2009-112154

(51) Int. Cl. G01S 13/88

(52) U.S. Cl. 342/70

(57) ABSTRACT

A vehicle radar apparatus that controls millimeter-wave radar operation is provided. The radar apparatus is configured to control the radar operation based on the speed of the vehicle. In the radar apparatus, the vehicle speed is detected and the output power of the radar apparatus (radar output power) is controlled such that the radar output power is set with at least two different output power levels in response to the vehicle speed.

### CROSS REFERENCE TO RELATED APPLICATION

This application is based on and claims the benefit of priority from earlier Japanese Patent Application No. 2009-112154 filed May 1, 2009, the description of which is incorporated herein by reference.

### BACKGROUND OF THE INVENTION

1. Field of the Invention

The present invention relates to a radar apparatus, more particularly to a radar apparatus that controls millimeter-wave radar.

2. Description of the Related Art

Conventionally, vehicle control units that automatically control a running state of the vehicle have been developed. For instance, a cruise control unit that controls vehicle speed to be constant and an adaptive cruise control unit that tracks a preceding vehicle by maintaining a predetermined distance to the preceding vehicle are known.

Specifically, patent documents, e.g. Japanese patent application laid-open numbers 1999-342766, 1997-324666 and 1999-268558 disclose a vehicle control unit that controls tracking of a preceding vehicle. In the vehicle control unit for tracking a preceding vehicle, a radar apparatus in the own vehicle detects the distance to the preceding vehicle and the running speed of the preceding vehicle whereby the vehicle control unit controls the own vehicle based on the detected distance data and the detected speed data. In addition, a patent document, Japanese patent number 4087803 discloses a method applied to millimeter-wave transmission/receiving module which can be used in a radar apparatus. In particular, a method for adjusting a bias circuit used for the transmission/receiving module is disclosed.

In the above-described related art, the radar apparatus is used to detect obstacles in front of the vehicle while the vehicle is running. However, to detect obstacles reliably while the vehicle is running, the radar apparatus usually operates with a large output power so that the energy efficiency of the radar apparatus may be decreased.

Moreover, according to a regulation specified by the Federal Communications Commission (FCC) in the U.S., when the vehicle is stopped, the output power of the radar wave is restricted to a predetermined value or less. To meet the regulation, while the vehicle is stopped, operation of the radar apparatus is disabled. However, obstacles in a detection area in front of the vehicle cannot be detected while the radar apparatus is disabled.

### SUMMARY OF THE INVENTION

The present invention has been made based on the above-described issues. An object of the present invention is to provide a radar apparatus which can be configured to increase the radar efficiency and to adequately detect obstacles in front of the vehicle in response to a running condition of the vehicle.

According to the first aspect of the present invention, a radar apparatus that controls millimeter-wave radar operation is provided. The radar apparatus is mounted on a vehicle and configured to control the radar operation based on a vehicle speed, the radar apparatus including: a vehicle speed detecting means that detects the vehicle speed; an output control means that controls the output power of the radar apparatus (radar output power); and an output power setting means for setting the output power of the radar apparatus with at least two different output power levels in response to the vehicle speed; wherein the output power setting means is configured to drive the output control means to change the output power to be the output power set by the setting means.

According to the above-described invention, the output power of the radar apparatus can be switched to at least two different power levels, in response to the vehicle speed. As described above, the running speed is detected by the vehicle speed detecting means (e.g. vehicle speed sensor) and a micro computer or the like controls the output power using the speed information. Therefore, obstacles in the necessary area that varies depending on the running speed, can readily be detected and as an effect of the present invention, energy efficiency of the radar apparatus can be improved.

Specifically, when the vehicle is running with relatively low speed, it is not necessary to set the detecting area of the radar apparatus wider compared to the vehicle is running with higher speed. Therefore, in the present invention, when the vehicle speed is low, the output of the radar apparatus can be lowered compared to the vehicle speed is high. As a result, the detecting area of the radar apparatus can be optimized based on the running condition of the vehicle and the energy efficiency of the radar apparatus can be enhanced.

Further, the radar output may be disabled when the vehicle is substantially stopped.

According to the second aspect of the present invention, to control the output power, the radar apparatus further includes: a monitoring means for monitoring the radar output power and a judging means for judging whether or not the output power is within a predetermined target range.

According to above-described invention, the radar apparatus can be configured to monitor the output power (e.g. output voltage) of the radar apparatus and to judge whether or not the radar output is within the predetermined target range. Hence, the radar apparatus can check whether or not the radar output is maintained within an optimized output range.

As a result, depending on the checking result, the radar apparatus can notify the checking result and can control the radar output to be a target value.

According to the third aspect of the present invention, the radar apparatus further includes a target tracking means for controlling the output power of the radar apparatus to be the predetermined target range when the judging means judges the output power is out of the predetermined target range.

According to above-described invention, when the judging means judges the radar output is out of the target range, the radar output is controlled to be the predetermined target range. Hence, the radar output power can be maintained to the optimized output range.

Besides, the target range can be varied based on a predetermined range, however, an individual target value may be used to control the output power to be maintained to the target value like a feed-back control.

According to the fourth aspect of the present invention, the radar apparatus further includes a disabling means for disabling the radar apparatus when the judging means judges the radar output power is out of the predetermined target range.

When the radar output power is not within the predetermined target range, it is possible that a fault has occurred in the apparatus. In this case, operation of the radar apparatus may be disabled. Alternatively, without disabling the radar apparatus, the radar apparatus may be configured not to use the radar information obtained by the radar apparatus itself.

According to the fifth aspect of the present invention, the radar apparatus includes a high frequency circuit using a monolithic microwave integrated circuit (MMIC). The radar apparatus is configured such that when the radar apparatus starts the operation, the bias voltage of the MMIC is adjusted whereby the radar output power is adjusted.

According to the above-described invention, a technique used to adjust the output power of the radar apparatus is exemplified. Specifically, adjusting the bias voltage higher allow the radar output power to increase. Conversely, adjusting the bias voltage lower allow the output power decrease.

According to the sixth aspect of the present invention, since the radar apparatus is configured to perform FMCW (Frequency-Modulated Continuous Wave) radar operation, the modulation period and the number of modulations of the FMCW signal is changed in order to adjust the radar output power.

According to the above-described invention, a technique used to adjust the output power of the radar apparatus is exemplified. Specifically, adjusting the modulation period longer or adjusting the number of modulations larger, allow the radar output power to increase. Conversely, adjusting the modulation period shorter or adjusting the number of modulations smaller allows the output power to decrease.

According to the seventh aspect of the present invention, the radar apparatus is configured to control the power supplied to the monolithic micro integrated circuit ON/OFF in response to a change of the modulation period and/or a change of the number of modulations. According to the above-described invention, since powering to the MMIC is ON/OFF controlled by the radar apparatus when the modulation period or the number of modulations are changed. Therefore, the power consumption can be effectively controlled whereby the energy efficiency is significantly improved.

Specifically, the radar apparatus controls the power supplied to the MMIC ‘ON’ during the change is made to the modulation period or the number of the modulations and controls the power supplied to the MMIC ‘OFF’ when the modulation period and the number of modulation are not changed. As a result, the energy efficiency can be enhanced.

### BRIEF DESCRIPTION OF THE DRAWINGS

In the accompanying drawings:

FIG. 1 is a block diagram showing an on-vehicle system including a radar apparatus of the first embodiment according to the present invention;

FIG. 2 is a block diagram showing a configuration of the radar apparatus;

FIG. 3 is a block diagram showing a detail configuration of the radar apparatus and the like;

FIG. 4 is an explanatory diagram showing a configuration used to adjust a bias voltage of a MMIC;

FIG. 5 is a block diagram showing a configuration used to compare a transmission voltage of the radar output and a reference voltage;

FIG. 6 is an explanatory diagram showing a setting range of a transmitting power of the radar output;

FIG. 7 is a flowchart showing a procedure for setting the transmitting power of the radar output according to the first embodiment;

FIG. 8 is a flowchart showing a procedure for judging the transmitting power of the radar output according to the first embodiment;

FIG. 9 is a block diagram showing a major portion of a radar apparatus according to the second embodiment;

FIGS. 10A to 10C are explanatory diagram showing a procedure for adjusting the transmitting power by using the FMCW signal;

FIG. 11 is a block diagram showing a major portion of a radar apparatus according the third embodiment;

FIG. 12 is an explanatory diagram showing a target value of the transmitting power of the radar output;

FIG. 13 is a flowchart showing a procedure for controlling the transmitting power of a radar apparatus according to the third embodiment to be a target value;

FIG. 14 is a flowchart showing a procedure for setting the transmitting power of a radar apparatus according to the fourth embodiment;

FIG. 15 is a flowchart showing a procedure for judging the transmitting power of the radar apparatus according to the fourth embodiment; and

FIG. 16 is a block diagram showing a major portion of a pulse radar system according to the modification.

### DESCRIPTION OF THE PREFERRED EMBODIMENTS

Hereinafter will be described a radar apparatus according to embodiments with reference to the drawings.

### First Embodiment

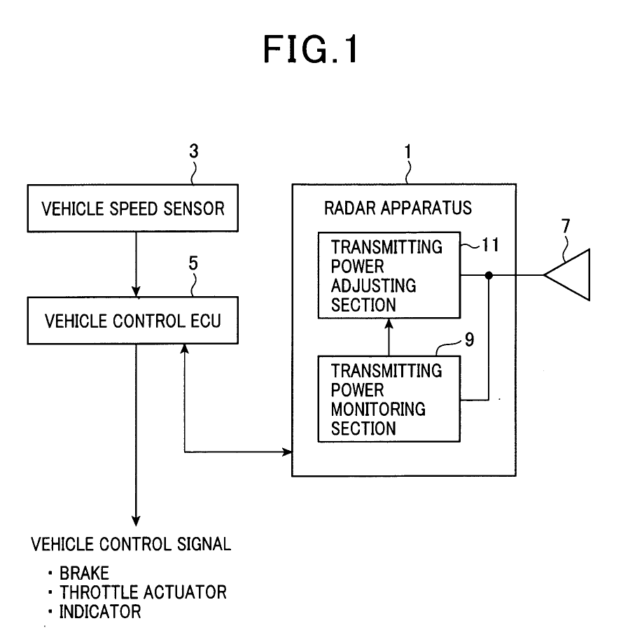

With reference to FIGS. 1 to 8, hereinafter will be described a first embodiment according to the present invention.

The radar apparatus according to the present invention controls the transmitting power of the radar apparatus in response to the vehicle speed. In addition, the radar apparatus is configured to have a function that monitors whether or not the transmitting power of the radar apparatus is within a target range.
a) First, a general configuration of a vehicle system including the radar apparatus of the first embodiment is described as follows.

As shown in FIG. 1, the vehicle provided with a radar apparatus 1, a vehicle speed sensor 3 and a vehicle control unit 5 i.e., vehicle control ECU (Electronic Control Unit). The radar apparatus 1 detects a running speed concerning a preceding vehicle that is running ahead of the own vehicle or a distance to the preceding vehicle and the like. The vehicle speed sensor 3 detects the running speed of the own vehicle and the vehicle control unit 5 controls the own vehicle based on information obtained by the radar apparatus 1 and the vehicle speed sensor 3.

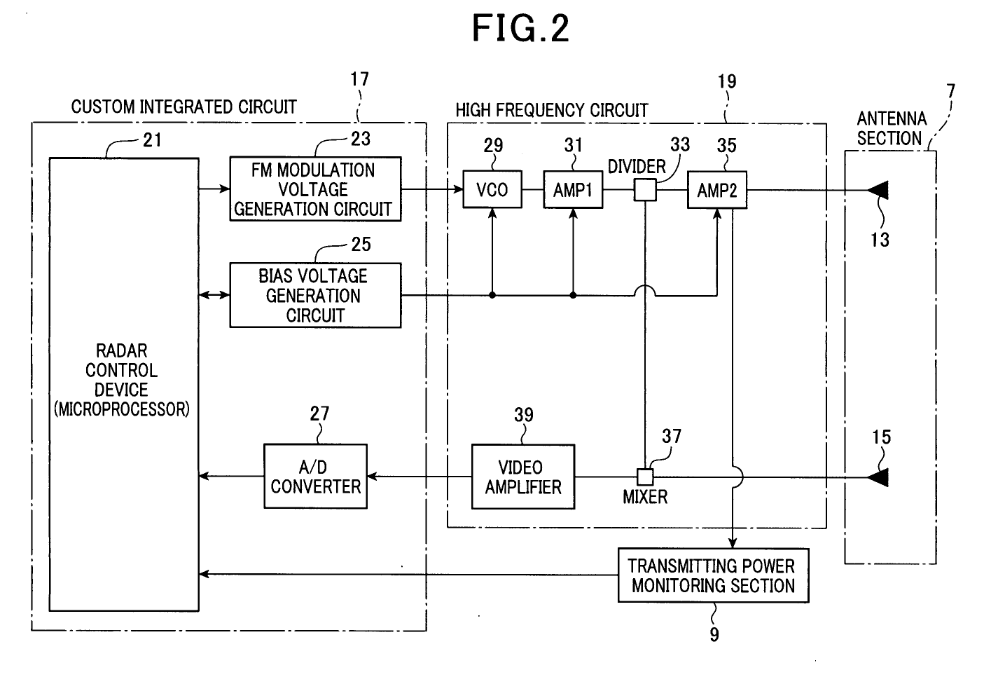

The radar apparatus 1 is configured to perform a FMCW millimeter-wave radar operation in which the frequency of the millimeter-waves to be transmitted is continuously modulated. The radar apparatus 1 includes a transmitting power adjusting section 11 that controls the transmitting power when the millimeter-waves are transmitted, an antenna section 7 that transmits the millimeter-waves towards the front of the vehicle and receives the reflected millimeter-waves, and a transmitting power monitoring section 9 that monitors the transmitting power of the millimeter-waves to be transmitted from the antenna section 7. The transmitting power adjusting section 11 controls the transmitting power based on the transmitting power detected by the transmitting power monitoring section 9.
b) Next, a configuration of the radar apparatus will be described in detail as follows. As shown in FIG. 2, the radar apparatus 1 includes the antenna section 7 comprising of a transmission antenna 13 and a reception antenna 15, and the transmitting power monitoring section 9. In addition, as the transmitting power adjusting section 11, the radar apparatus 1 includes a custom integrated circuit (IC) 17 and a high frequency circuit 19.

The custom IC 17 includes an electronic control device (microprocessor) as a radar control device 21, a FM modulation voltage generation circuit 23 that generates triangular waves used for generating of the FMCW signal, a bias voltage generation circuit 25 that generates bias voltage and an analog to digital (A/D) converter 27. The radar control device 21 controls transmission and reception operation of the radar apparatus 1.

Further, as a configuration of the transmission section, the high frequency circuit 19 includes a voltage control oscillator (VCO) 29, an amplifier 31 (AMP1) that amplifies a signal, a divider 33 and an amplifier 35 (AMP21) that amplifies a signal. The voltage control oscillator 29 generates the FMCW signal in response to the triangular waves being received. The divider 33 is configured to divide the FMCW signal, and distributes the divided FMCW signal to the transmission section and a receiving side as a local signal. Also, as a configuration of a receiving section, the high frequency circuit includes a mixer 37 that receives the local signal transmitted by the divider 33 and a video amplifier 39 that amplifies the received signals and the like.

The transmitting power monitoring section 9 is connected to the amplifier 35. The transmitting power monitoring section 9 monitors the voltage signal at the amplifier 35 that represents the transmitting power and the voltage signal is inputted to the radar control device 21.
c) Next, a measurement operation of the radar apparatus 1 will be described as follows.
   As shown in FIG. 2, in the radar apparatus 1, the VCO 29 generates the FMCW signal in response to the triangular waves generated by the FM modulation voltage generation circuit 23. The FMCW signal includes an increasing-modulation signal in which the frequency of the signal increases during a constant period (increasing-modulation period) and a decreasing-modulation signal in which the frequency of the signal decreases during a constant period (decreasing-modulation period).

The FMCW signal divided by the divider 33 or the like is supplied to the transmission antenna 13. Then, the millimeter-waves are emitted via the transmission antenna 13 to a target object. Further, the rest of divided FMCM signal is supplied to the mixer 37 as a local signal. The FMCW signal is, for instance, 70 GHz millimeter-wave.

The reflected waves acquired by the reception antenna 15 are inputted to the mixer 37 as a received signal. The mixer 37 mixes the received signal from the reception antenna 15 and the local signal from the divider 33 and outputs a beat signal of which frequency is a frequency difference between both signals.

This beat signal is inputted to the radar control device 21 via the A/D converter 27 after the video amplifier 39 amplifies the beat signal to be appropriate signal level. The radar control device 21 calculates the distance to the target object and the speed of the target object by using the frequencies corresponding to the increasing-modulation period and the decreasing-modulation period in the inputted beat signal.
d) Herein after will be described a configuration of a bias adjusting section used for adjusting the transmitting power of the radar apparatus according to the present invention and an operation thereof. As shown in FIG. 2, in the high frequency circuit 19, each of the transmission section (divider 33 or the like) and the receiving section (mixer 37, video amplifier 39 or the like) is configured as a plurality of monolithic microwave integrated circuit (MMIC). Also, the VCO 29 comprises a plurality of MMIC to generate 70 GHz band millimeter-wave signal in which the MMICs are connected in multi-stages used to multiply a signal having frequency e.g. 19 GHz to obtain the required frequency 70 GHz.

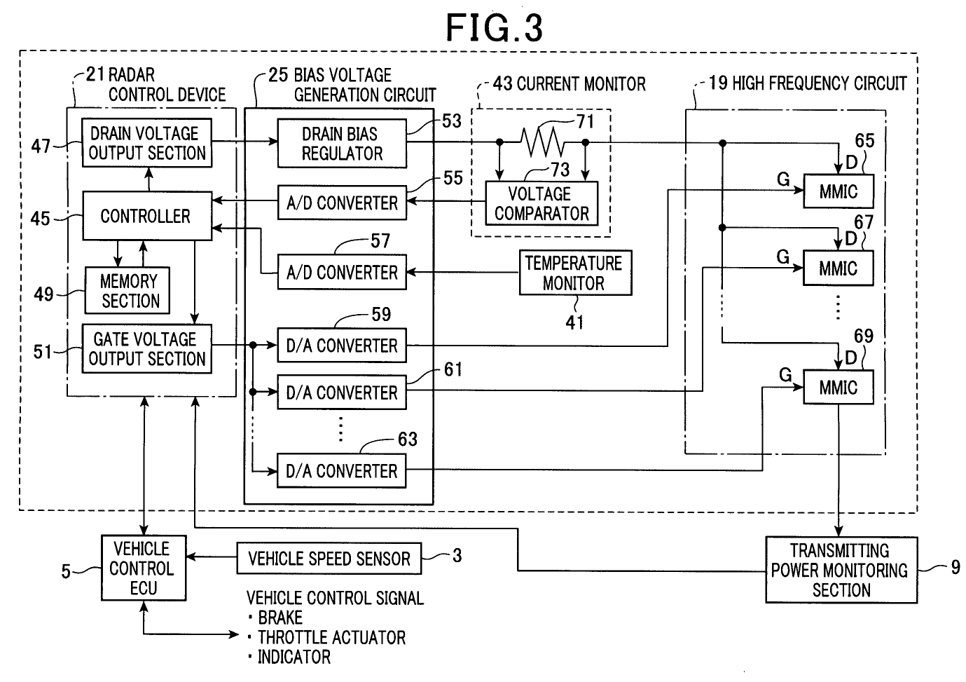

According to the first embodiment, a bias voltage adjusting section having the MMIC is configured to include the radar control device 21 as follows. As shown in FIG. 3, a temperature monitor 41 that detects the ambient temperature in the high frequency circuit 19 and a current monitor 43 that detects the drain current flowing through the MMIC are arranged closely to the high frequency circuit 19. The output of the temperature monitor 43 is inputted to the radar control device 21 via the bias voltage generation circuit 25. Similarly, the output of the current monitor 43 is inputted to the radar control device 21 via the bias voltage generation circuit 25.

In addition to the above-described transmission procedure and the measurement procedure in the FMCW radar apparatus, the radar control device 21 allows the bias voltage generation circuit 25 to supply bias voltages to each MMIC. The bias voltages are set by the radar control device 21 based on each output of the temperature monitor 41 and the current monitor 43 which are inputted to the radar control device 21 via the bias voltage generation circuit 25.

The bias voltages are adjusted individually for three MMIC groups i.e., the MMICs adapted to the transmission section, the MMICs adapted to the receiving section, and the MMICs used for the frequency multiplying. Therefore, above-described each MMIC group is assigned to individual bias adjusting section.

As shown in FIG. 3, the radar control device 21 is provided with a controller 45, a drain voltage output section 47, memory section 49 and a gate voltage output section 51. The controller 45 performs a drain voltage setting procedure and a bias adjusting procedure for gate voltage. The drain voltage output section 47 is configured to output the drain voltage to be set by the controller 45. The memory section 49 includes a temperature table to be referred by the controller 45 when the drain voltage is set, a data region used for the controller 45 when the bias for the gate voltage is adjusted and a temperature table to be referred by the controller 45 when the gate voltage is set. The gate voltage output section 51 is configured to output the gate voltage to be set by the controller 45.

The bias voltage generation circuit 25 includes a drain bias regulator 53 having a digital to analog (D/A) converter on the input stage, an A/D converters 55, 57 and (n-pieces of) D/A converters 59, 61, 63. The high frequency circuit 19 is provided with (n-pieces of) MMICs 65, 67, 69 which are one of above-described three MMIC groups. Further, above-described temperature monitor 41 and the current monitor 43 is disposed in a portion close to the high frequency circuit 19. The current monitor 43 comprises a shunt resistor 71 and a voltage comparator 73.

Moreover, output of the drain voltage output section 47 is supplied to the drain bias regulator 53. The output of the drain bias regulator 53 is supplied to each drain electrode D of the MMICs 65 to 69 via the shunt resistor 71. The voltage across the shunt resistor 71 is inputted to the voltage comparator 73 and the output of the voltage comparator 73 is inputted to the controller 45 via the A/D converter 55. The output of the temperature monitor 41 is inputted to the controller 45 via the A/D converter 57. The D/A converters 59 to 63 are connected to the output terminal of the gate voltage output section 51 in parallel. The outputs of the D/A converters 59 to 63 are connected to the gate electrodes G of the corresponding MMICs 65 to 69 respectively.

In the first embodiment, the bias voltage is adjusted using above-described configuration in order to adjust the transmitting voltage. However, the adjustment procedure is similar to a procedure described in the patent document 4087803. Accordingly, the explanation for this procedure will be summarized as follows.

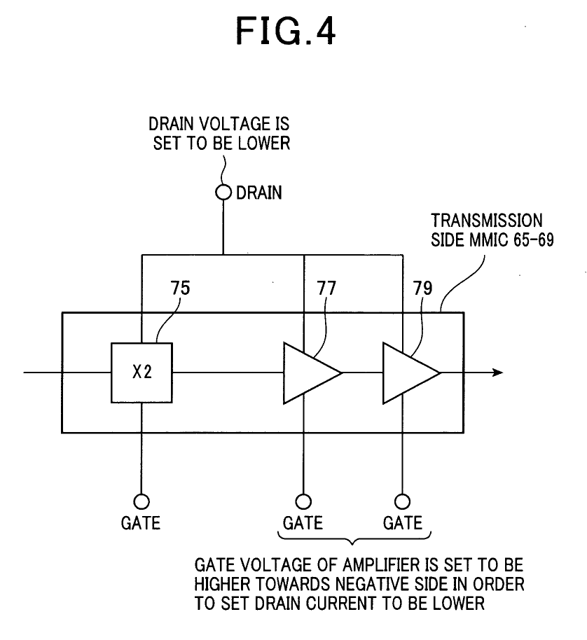

As shown in FIG. 4, amplifier sections 75, 77 and 79 are arranged in the transmission side MMIC 65 to 69 and the amplifier sections are configured such that the drain voltages of the amplifier section 75 to 79 are set to be lower and the gate voltages of the amplifier section 77 and 79 are set to be higher (towards negative side) in order to set the drain current to be lower. As a result, the transmitting power can be decreased by lowering the bias voltage.

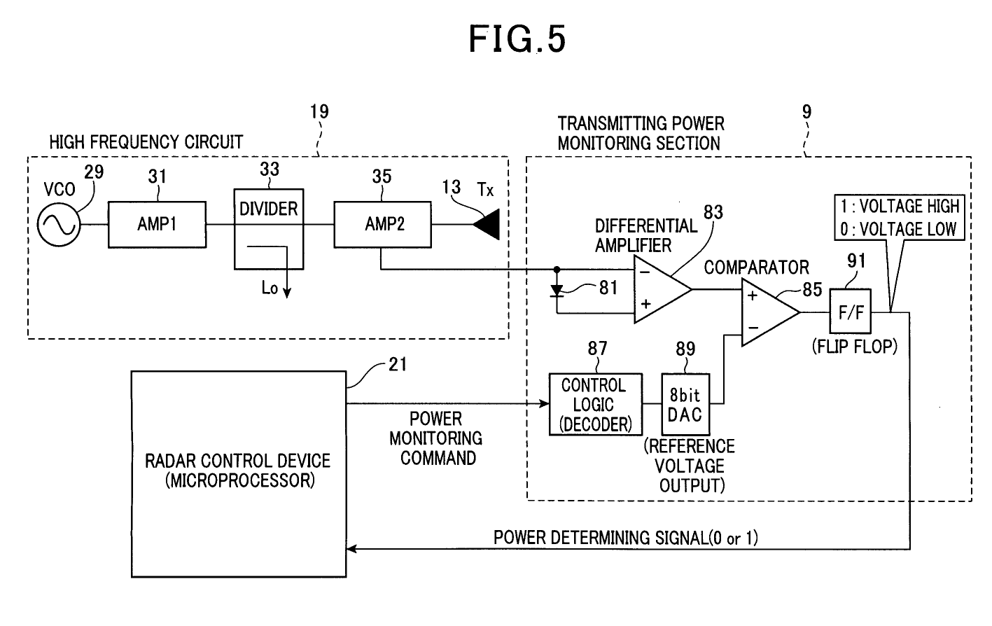

Conversely, the amplifier section can be configured such the drain voltages of the amplifier sections 75 to 79 are set to be higher and the gate voltages of the amplifier sections 77 and 79 are set to be lower (towards negative side) in order to set the drain current to be higher. As a result, the transmitting power can be increased by the higher bias voltage.
e) Next, a configuration used for monitoring transmitting power that constitutes a feature of the first embodiment is described as follows. As shown in FIG. 5, the transmitting power monitoring section 9 includes a detection diode 81, a differential amplifier 83, a comparator 85, a decoder (control logic) 91, 8-bit D/A converter (DAC) 89 and a flip-flop (F/F) 91.

In the transmitting power monitoring section 9, the transmitting power (transmission voltage) from the amplifier 35 of the high frequency circuit 19 is inputted to the detection diode 81. The voltage across the detection diode 81 indicates the transmission voltage (i.e., electric potential difference).

Therefore, a signal corresponding to the transmission voltage can be obtained by the differential amplifier 83 that receives the voltage across the detection diode 81.

The differential amplifier 83 is configured to amplify the signal corresponding to the transmission voltage and the signal is inputted to the input terminal (+) of the comparator 83. Meanwhile, the radar control device 21 outputs a power monitoring command to a decoder 87. The power monitoring command serves to have the DAC 89 output a reference voltage via the decoder 87.

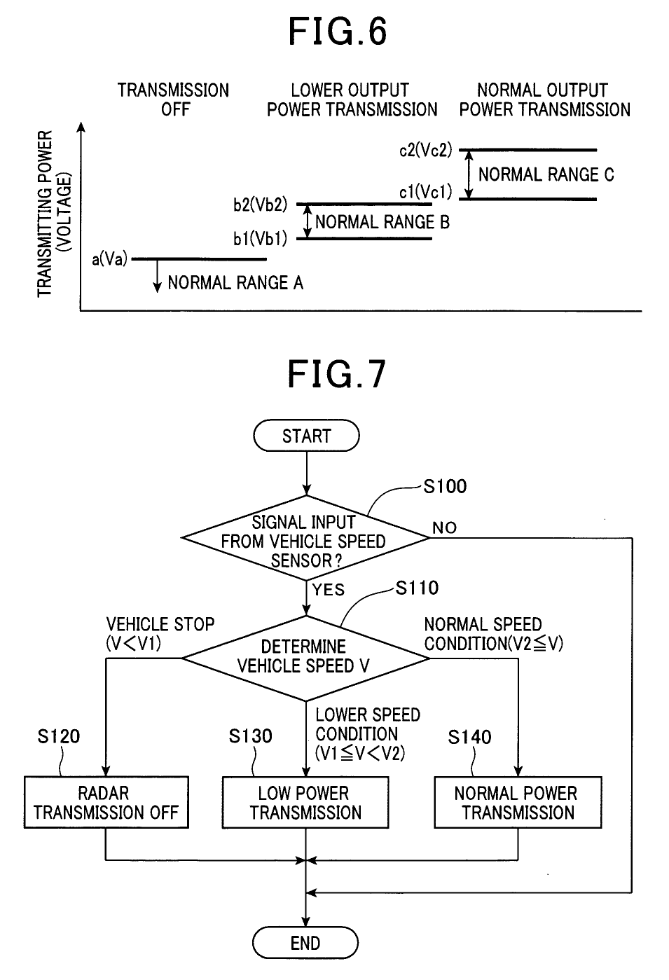

As shown in FIG. 6, in the first embodiment, the range of the transmitting power is classified to three ranges that is, a lower output range A that indicates transmission Off state (the transmitting power is lower), an intermediate output range B that indicates intermediate transmitting power and a higher output range C that indicates higher transmitting power. To delimit each range, boundary values (boundary-output) i.e., a, b1, b2, c1 and c2 (specifically, reference voltages (Va, Vb1, Vb2, Vc1 and Vc2) corresponding to each boundary-output, where Va<Vb1<Vc1<Vc2) are defined. Hence, the power monitoring command serves to have the DAC 89 output each reference voltage that corresponds to the boundary output.

Accordingly, when the signal from the decoder 87 is inputted to the DAC 89 in response to the received power monitoring command, the reference voltage is inputted to the input terminal (−) of the comparator 85 by the DAC 89. Then, the comparator 85 compares the input signal from the differential amplifier 83 with the input signal from the DAC 89. The comparator outputs ‘1’ when the radar transmitting power (transmission voltage) is higher than the reference voltage and outputs ‘0’ when the radar transmitting power is lower than the reference voltage. The output of the comparator 85 (i.e., judging result: 1 or 0) is held in the F/F 91 and a power determining signal which indicates the judging result from the F/F 91 is outputted to the radar control device 21.

Therefore, the radar control device 21 can determine whether or not the radar transmission voltage is higher than the reference voltage or not. As a result, the radar control device 21 can judge whether or not the radar transmission voltage (i.e., transmitting power) is appropriate for the vehicle speed.
f) Hereinafter will be described a control procedure executed by the radar control device 21 in the radar apparatus 1 according to the first embodiment.
1) A Procedure for Adjusting a Radar Transmitting Power in Response to the Vehicle Speed is Described
   As shown in FIG. 7, at step 100 (S100), it is judged whether or not the signal is inputted from the vehicle speed sensor 3. The radar control device 21 proceeds to step 110, otherwise, terminates the procedure.

At step 110, the radar control device 21 determines the vehicle speed based on the signal from the vehicle speed sensor 3. Specifically, the vehicle speed V is determined with following three conditions:

V<V1; the speed V1 indicates the vehicle speed is substantially the same speed of the vehicle-stop (e.g. 2 km/hour), or
V≧V2; the speed V2 indicates the vehicle is in a normal speed condition (e.g. 30 km/h), or
V1≦V<V2; the speed V indicates the vehicle is in a lower speed condition.

The radar control device 21 proceeds to step 120 when the vehicle is in the stop condition, proceeds to step 130 when the vehicle is in the lower speed condition and proceeds to step 140 when the vehicle is in the normal speed condition.

Subsequently, at step 120, since the vehicle is in the stop condition, it is judged that the radar apparatus 1 does not have to be operated. Hence, the supply voltage to the MMIC 65 to 69 is switched off in order to disable the transmitting of the radar-wave and the radar control device 21 terminates the procedure. The state of the transmitting power in this vehicle-stop condition corresponds to the lower output range A. Instead of switching off the transmitting of the radar-wave, in order to detect obstacles near the vehicle-surroundings, the radar waves can be transmitted within the lower output range A.

Also, at step 140, since the vehicle is in the normal speed condition, the radar control device 21 transmits the radar waves by using normal power range which is a predetermined initial value and terminates the procedure. The state of the transmitting power in this normal speed condition corresponds to the higher output range C.

Moreover, at step 130, since the vehicle is in the lower speed condition, detecting vehicles in the distance is not necessary. Hence, the radar control device 21 transmits the radar waves by using lower power and terminates the procedure. The state of the transmitting power in this lower speed condition corresponds to the intermediate output range B.

Specifically, as shown in FIG. 4, the drain voltages of the amplifier sections 75 to 79 are set to be lower (compared to the normal transmitting power range) and the gate voltages of the amplifier section 77 and 79 are set to be higher in order to set the drain current to be lower (compared to the normal transmitting power range). As a result, the transmitting power can be decreased by lowering the bias voltage.

For setting the drain voltages and gate voltages which determines the transmitting power, each transmitting power value corresponding to the each drain/gate voltages are specified in a rating table or the like in the specification of the apparatus.
2) Procedure for Determining Whether or not the Radar Transmitting Power is in a Proper Power Range
   First, a procedure of comparing the voltage is described as follows.

As shown in FIG. 5, since the transmitting voltage when the radar waves are transmitted is inputted to the input terminal (+) of the comparator 85, to verify the transmitting voltage, the radar control device 21 outputs a command so as to input the reference voltage to the input terminal (−) of the comparator 85.

Subsequently, as shown in FIG. 6, it is determined whether or not the output range of the transmitting power corresponds to either one of the output ranges i.e., the lower output range A, the intermediate output range B and the higher output range C. This is determined by using reference voltages consisting of Va1, Vb1, Vb2, Vc1 and Vc2 which corresponds to boundary-outputs a, b1, b2, c1, c2 respectively.

Specifically, as shown in FIG. 5, the radar control device 21 sends a command to the decoder 87 to have the DAC 89 output e.g. reference voltage Va. The comparator 85 compares the transmitting power at the moment i.e., transmitting voltage with the reference voltage Va. The F/F 91 outputs ‘1’ when the transmitting voltage is larger than the reference voltage Va, otherwise, outputs ‘0’. Therefore, the radar control device 21 can determine the relationship in magnitude between the transmitting voltage and the reference voltage Va. Similarly, the transmitting voltage can be compared with the reference voltages Vb1, Vb2, Vc1 and Vc2.

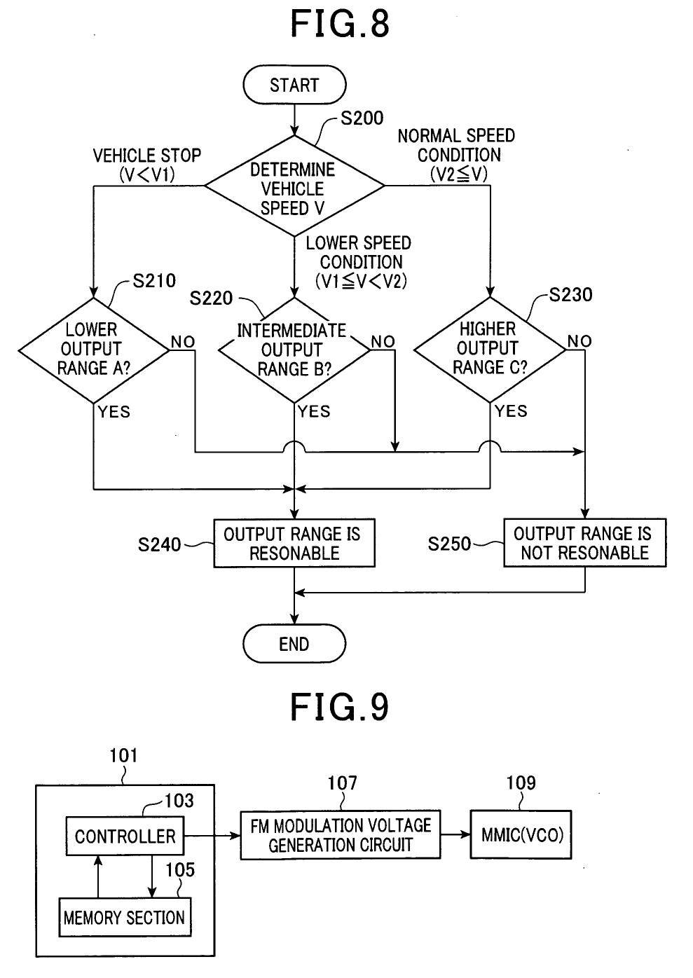

Next, procedure for judging appropriateness of the radar transmitting power will be described as follows. The judgment is made using a judgment of the vehicle speed and a judgment of the voltage comparison. As shown in FIG. 8, at step 200, the vehicle speed is determined based on the speed sensor 3. Specifically, it is judged that whether the vehicle speed V is substantially the same speed of the vehicle-stop i.e., the speed V is less than V1 (V<V1) or the vehicle speed V is equal to or more than V2 showing the normal speed condition (V2≦V) or the vehicle speed is the lower speed condition i.e., the speed V is V1≦V<V2.

When it is judged the vehicle is in the stop condition, the radar control 25, device 21 proceeds to step 210, when it is judged the vehicle is in lower speed condition, the radar control device 21 proceeds to step 220 and it is judged the vehicle is in the normal speed condition, the radar control device 21 proceeds to step 230.

At step 210, the vehicle is in the stop condition so that the radar apparatus does not have to be operated. Hence, it is judged whether or not the transmitting power of the radar apparatus (radar transmitting power) is in a lower output range A. Specifically, it is judged whether or not the transmitting power is equal to or less than the reference voltage Va. At the moment, if the judgment is Yes, then the radar control device 21 proceeds to step 240, if judgment is No, then radar control device 21 proceeds to step 250.

At step 240, since the radar transmitting power is in the lower output range A when the vehicle is in the stop condition, it is judged the radar transmitting power is reasonable. Then, the radar control device 21 sets a flag in order to indicate the judging result and terminates the procedure.

Meanwhile, at step 250, since the radar transmitting power is out of the lower output range A when the vehicle is in the stop condition, it is judged the radar transmitting power is not reasonable. Then, the radar control device 21 set the flag in order to indicate the judging result and terminates the procedure.

Also, at step 220, since the vehicle is in the lower speed condition, the radar apparatus 1 has to be operated with a lower output. Hence, it is judged whether or not the radar transmitting power is in the intermediate output range B. Specifically, it is judged whether or not the transmitting voltage is equal to or more than the reference voltage Vb1, and equal to or less than Vb2. If the judgment is Yes, then the radar control device 21 proceeds to step 240, if the judgment is No, the radar control device 21 proceeds to step 250.

At step 240, since the radar transmitting power is in the intermediate output range B when the vehicle is in the lower speed condition, it is judged the radar transmitting power is reasonable. Then, the radar control device 21 set the flag in order to indicate the judging result and terminates the procedure.

Meanwhile, at step 250, since the radar transmitting power is out of the intermediate output range B when the vehicle is in the lower speed condition, it is judged the radar transmitting power is not reasonable. Then, the radar control device 21 set the flag in order to indicate the judging result and terminates the procedure.

Moreover, at step 230, since the vehicle is in normal speed condition, the radar apparatus 1 has to be operated with a normal output. Hence, it is judged whether or not the radar transmitting power is in the higher output range C. Specifically, it is judged whether or not the transmitting voltage is equal to or more than the reference voltage Vc1 and equal to or less than Vc2. If the judgment is Yes, then the radar control device 21 proceeds to step 240, if the judgment is No, the radar control device 21 proceeds to step 250.

At step 240, since the radar transmitting power is in the higher output range C when the vehicle is in the normal speed condition, it is judged the radar transmitting power is reasonable. Then, the radar control device 21 set the flag in order to indicate the judging result and terminates the procedure.

Meanwhile, at step 250, since the radar transmitting power is out of the higher output range C when the vehicle is in the normal speed condition, it is judged the radar transmitting power is not reasonable. Then, the radar control device 21 set the flag in order to indicate the judging result and terminates the procedure.

g) As described above, the radar apparatus 1 according to the first embodiment, the radar transmitting power is controlled in response to the vehicle speed and also, it is monitored whether or not the radar transmitting power is outputted in response to the vehicle speed. Therefore, the radar control device 21 always recognizes whether or not appropriate transmitting power is outputted.

As a result, the radar transmitting power can be appropriately adjusted and abnormalities on the radar apparatus 1 can be detected. Hence, the radar control can be favorably performed.

### Second Embodiment

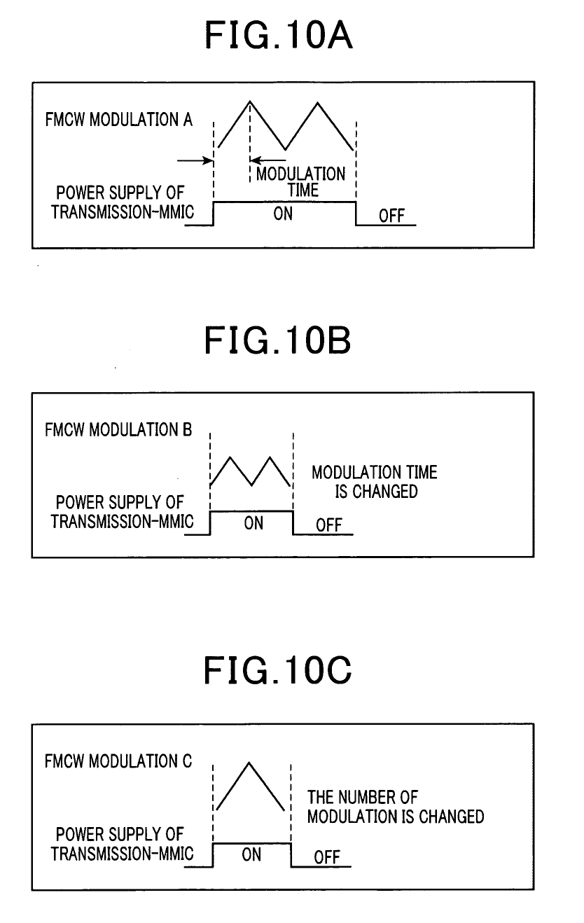

With reference to FIGS. 9 to 10A-10C, hereinafter will be described the second embodiment. However, explanations of which contents similar to the first embodiment are omitted. In the second embodiment, the control procedure of the radar transmitting power differs from the first embodiment. As shown in FIG. 9, a major portion of the radar apparatus according to the second embodiment is shown. The radar control device 101 includes a controller 103 and a memory section 105. A FM modulation voltage generation circuit 107 which is connected to the radar control device 101 outputs triangular waves which is sent to a VCO 109 of the MMIC.

Specific procedures for adjusting the radar transmitting power are described as three types of procedures a) to c) as follows. Here is described a procedure in which the transmitting power when the vehicle is in the normal speed condition is switched to the transmitting power when the vehicle is in lower speed condition.

### FMCW Modulation A

As shown in FIG. 10A, when the FMCW modulation is performed, a modulation time for the triangular waves (i.e., time between inflection points) which is outputted from the FM modulation voltage generation circuit 107 is set. Specifically, a period between a starting point of a rise in the frequency and starting point of fall in the frequency (similarly, a period between a starting point of a fall in the frequency and starting point of rise in the frequency).

Here, the modulation time is set as an initial value corresponding to the higher output range C in the normal speed condition. However, the power supply of the MMIC used for transmitting turns ON only when the modulation is performed. Otherwise, the power supply of the MMIC turns off.

Therefore, efficiency of the energy in the radar apparatus 1 can be enhanced.

### FMCW Modulation B

As shown in FIG. 10B, when the FMCW modulation is performed, the modulation time of the triangular waves outputted from the FM modulation voltage generation circuit 107 is changed whereby the total modulation time can be changed. Specifically, the radar transmitting power is decreased by shortened modulation time.

Also, on-time of the power supply for the MMIC used for transmitting can be shortened thereby efficiency of the energy in the radar apparatus 1 can be enhanced.

### FMCW Modulation C

As shown in FIG. 10C, when the FMCW modulation is performed, the number of triangular waves outputted from the FM modulation voltage generation circuit 107 is changed. Specifically, the radar transmitting power is decreased by reducing the number of modulations.

Further, on-time of the power supply for the MMIC used for transmitting can be shortened thereby efficiency of the energy in the radar apparatus 1 can be enhanced. Therefore, the radar apparatus 1 according to the second embodiment can produce similar advantages of the first embodiment.

### Third Embodiment

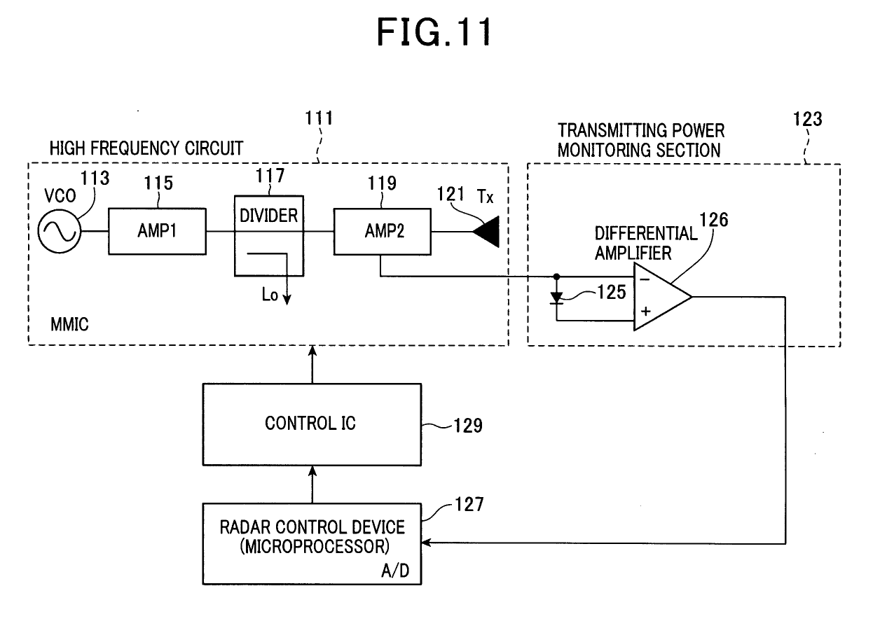

With reference to FIGS. 11 to 13, hereinafter will be described the third embodiment. However, explanations of which contents similar to the first embodiment are omitted. In the third embodiment, the radar transmitting power of the radar apparatus is monitored and the radar transmitting power is controlled in response to the vehicle speed.
a) First, a configuration used for monitoring the transmitting power and controlling the transmitting power which are features of the present invention is described as follows. As shown in FIG. 11, as similar to the first embodiment, a high frequency board 111 includes a VCO 113, an amplifier (AMP 1) 115, a divider 117, an amplifier (AMP 2) 119, transmission antenna 121 and the like.
   As shown in FIG. 11, a transmitting power monitoring section 123 includes a detection diode 125, a differential amplifier 126 and the like. In the transmitting monitoring section 123, the transmitting power (transmission voltage) from the amplifier 119 of the high frequency circuit 111 is inputted to the detection diode 125. Since, the voltage across the detection diode 125 indicates the transmission voltage (i.e., electric potential difference), the voltage across the detection diode 125 is inputted to the differential amplifier 125. Then, the differential amplifier 125 amplifies the input signal and the amplified signal is inputted to the radar control device 127 (microprocessor) after the A/D conversion.

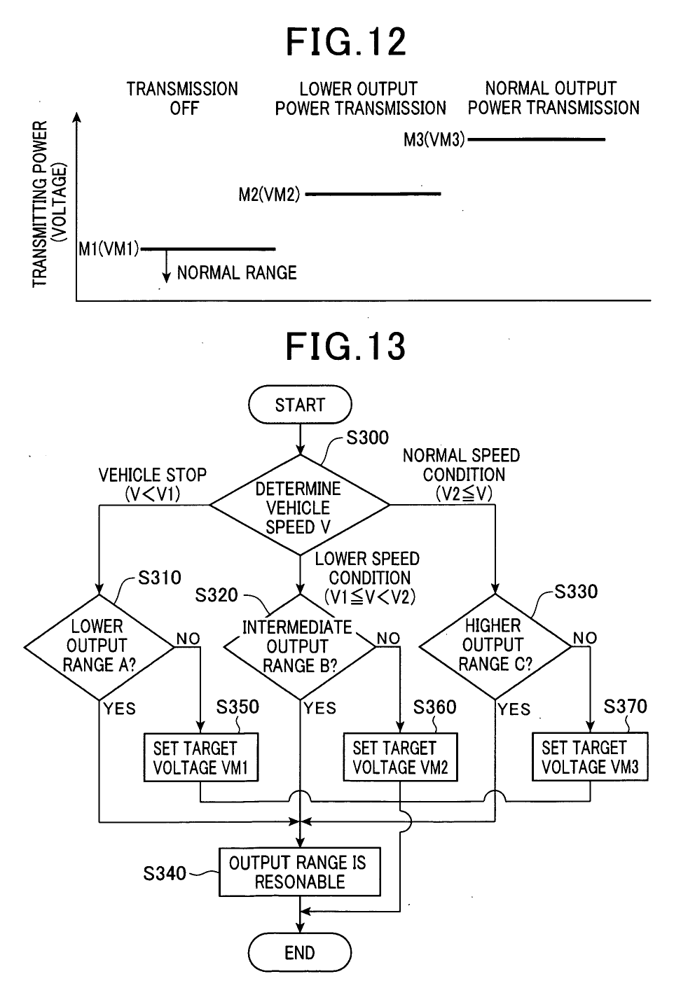

The radar control device 127 drives a control IC 129 based on the signal indicating the transmitting power from the differential amplifier 125 whereby control the MMIC of the high frequency circuit 111. As shown in FIG. 12, as similar to the first embodiment, the bias voltage is adjusted whereby the radar transmitting power is maintained to be the target value.

As shown in FIG. 12, in the third embodiment, the target value of the transmitting power is set corresponding to the output ranges. Specifically, a target power M1 (target voltage VM1) is set corresponding to the lower output range A that indicates the transmission Off state, a target power M2 (target voltage VM2) is set corresponding to the intermediate output range B and a target power M3 (target voltage VM3) corresponding to the higher output range C. As a result, the radar output voltage is controlled to be the relevant target voltage.

Further, a value corresponding to the center of the lower output range A (the center value of the vertical axis) can be adapted to the target voltage VM1, a value corresponding to the center of the intermediate output range B can be adapted to the target voltage VM2 and a value corresponding to the center of the higher output range C can be adapted to the target voltage VM3. Here, the relationship between the target voltages will be VM1<VM2<VM3.

b) Next, a control procedure executed in the radar apparatus according to the third embodiment is described as follows.

### <Procedure for Adjusting the Radar Transmitting Power in Response to the Vehicle Speed>

As shown in FIG. 13, at step 300, the radar control device 127 determines the vehicle speed based on the signal from the vehicle speed sensor 3. Specifically, the vehicle speed V is determined with following three conditions:

V<V1; the speed V1 indicates the vehicle speed is substantially the same speed of the vehicle-stop, or
V≧V2; the speed V2 indicates the vehicle is in a normal speed condition, or
V1≦V<V2; the speed V indicates the vehicle is in a lower speed condition.
When the vehicle is stop condition, the radar control device 127 proceeds to step 310, when the vehicle is in the lower speed condition, the radar control device 127 proceeds to step 320 and when the vehicle is in normal speed condition, proceeds to step 330.

At step 310, the vehicle is in stop condition, the radar apparatus 1 does not have to be operated, it is judged whether or not the radar transmitting power corresponds to the lower output range A. Specifically, it is judged whether or not the transmitting power is equal to or less than the reference voltage Va. Then, the radar control device 127 proceeds to step 340 when the judgment is Yes, and proceeds to step 350 when the judgment is No.

At step 340, since the radar transmitting power is in the lower output range A when the vehicle is in the stop condition, it is judged the radar transmitting power is reasonable. Then, the radar control device 127 sets the flag in order to indicate the judging result and terminates the procedure. Meanwhile, at step 350, since the radar transmitting power is out of the lower output range A when the vehicle is in the stop condition, the radar control device 127 controls (i.e., feed back control) the radar transmitting power to be the target value M1 corresponding to the lower output range A (i.e., target voltage VM) and terminates the procedure.

Also, at step 320, since the vehicle is in the lower speed condition, the radar apparatus 1 has to be operated with a lower output. Hence, it is judged whether or not the radar transmitting power is in the intermediate output range B. Specifically, it is judged whether or not the transmitting voltage is equal to or more than the reference voltage Vb1, and equal to or less than Vb2. If the judgment is Yes, then the radar control device 127 proceeds to step 340, if the judgment is No, the radar control device 127 proceeds to step 360.

At step 360, since the radar transmitting power is out of the intermediate output range B when the vehicle is in the lower speed condition, the radar control device 127 controls the radar transmitting power to be the target value M2 corresponding to the intermediate output range B (i.e., target voltage VM2) and terminates the procedure.

Moreover, at step 360, since the vehicle is in normal speed condition, the radar apparatus 1 has to be operated with a normal output. Hence, it is judged whether or not the radar transmitting power is in the higher output range C. Specifically, it is judged whether or not the transmitting voltage is equal to or more than the reference voltage Vc1 and equal to or less than Vc2. If the judgment is Yes, then the radar control device 127 proceeds to step 340, if the judgment is No, the radar control device 127 proceeds to step 370.

Meanwhile, at step 370, since the radar transmitting power is out of the higher output range C when the vehicle is in the normal speed condition, the radar control device 127 controls the radar transmitting power to be the target value M3 corresponding to the intermediate output range C (i.e., target voltage VM3) and terminates the procedure.

Accordingly, the above-described control procedure in the third embodiment produces a significant advantage in which the radar transmitting power can always be optimized in response to the vehicle speed. Further, for example, when the radar output is not within a target range, it is possible that some abnormality may have occurred in the radar apparatus. Therefore, the operation of the radar apparatus may be stopped or a control procedure based on the information obtained by the radar apparatus may be suspended or the vehicle control may be performed without using the information obtained by the radar apparatus.

### Fourth Embodiment

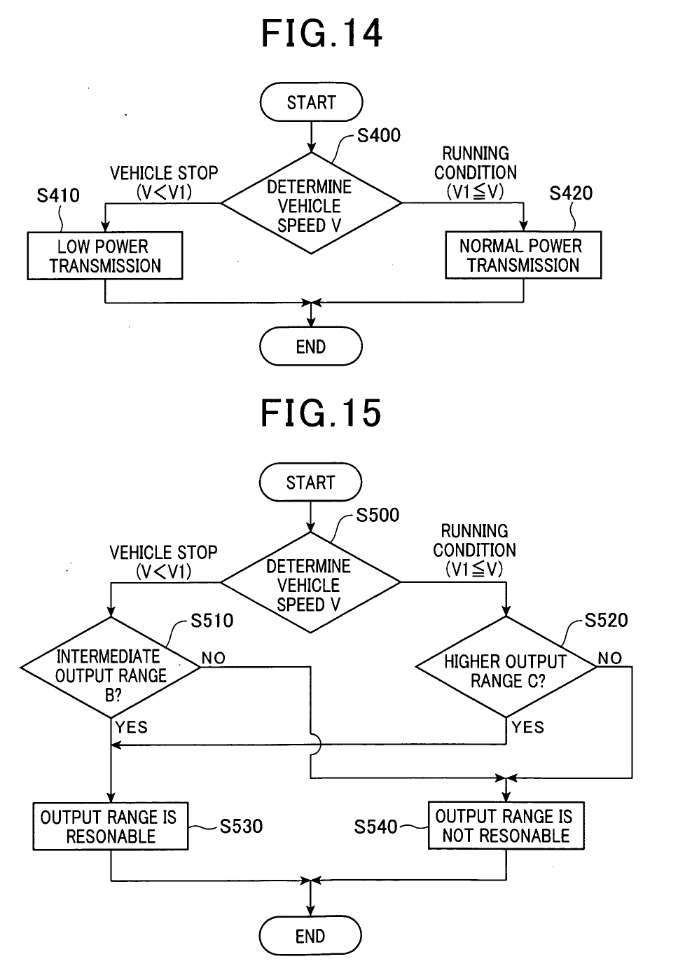

With reference to FIGS. 14 and 15, hereinafter will be described the fourth embodiment. However, explanations of which contents similar to the first embodiment are omitted. Since the fourth embodiment features a content of the control procedure compared to other embodiments, the contents thereof is described as follows.

Procedure for adjusting the radar transmitting power in response to the vehicle speed.
As shown in FIG. 14, at step 400, the vehicle speed is determined based on the signal from the vehicle sensor 3. Specifically, it is determined whether or not the vehicle speed V meets the conditions, i.e., V<V1; the speed V1 indicates the vehicle speed is substantially the same speed of the vehicle-stop (e.g. 2 km/hour); or the vehicle speed V is equal to or more than V1.
Here, the radar control device 127 proceeds to step 240 when the vehicle is in the stop condition and proceeds to step 420 when the vehicle is in the normal speed condition. At step 410, to recognize the vehicle-surroundings close to the vehicle when the vehicle is stopped (rather than running condition), the radar waves are transmitted with lower transmitting power and the radar control device 127 terminates the procedure.

Meanwhile, at step 420, since the vehicle is in normal running condition (rather than stop condition), the radar waves are transmitted with the normal power range which is larger than the transmitting power used when the vehicle is in stop condition to detect a situation of the surroundings in the distance and terminates the procedure.
(2) Procedure for Determining Whether or not the Radar Transmitting Power is in a Proper Power Range
   As shown in FIG. 15, at step 500, the vehicle speed is determined based on the signal from the vehicle speed sensor 3. Specifically, it is judged whether the vehicle speed V is substantially the same speed of the vehicle-stop i.e., the speed V is less than V1 (V<V1) or the speed V is equal to or more than V1. The radar control device 127 proceeds to step 510 when the vehicle is in stop condition and proceeds to step 420 when the vehicle is in running condition. At step 410, since the vehicle is in stop condition, it is not necessary to perform radar scanning in the distance. Therefore, it is judged whether or not the radar transmitting power is in the intermediate transmitting power range B. As a result, when the judgment is Yes, the radar control device 127 proceeds to step 530 and when the judgment is No, the radar control device 127 proceeds to step 540.

At step 530, since the radar transmitting power is in the intermediate transmitting power range B when the vehicle is in the stop condition, it is judged the radar transmitting power is reasonable. Then, the radar control device 127 set the flag in order to indicate the judging result and terminates the procedure.

Meanwhile, at step 540, since the radar transmitting power is out of the intermediate transmitting power range when the vehicle is in stop condition, it is judged the radar transmitting power is not reasonable. Then, the radar control device 127 set the flag to indicate the judging result and terminates the procedure.

Also, at step 520, since the vehicle is in running condition thereby the radar apparatus 1 need to operate with normal output power range, it is judged whether or not the radar transmitting power is in the higher transmitting power range C. As a result, when the judgment is Yes, the radar control device 127 proceeds to step 530 and when the judgment is No, the radar control device 127 proceeds to step 540.

In the fourth embodiment, the radar transmitting power is controlled in response to the vehicle speed and is monitored whether or not the output of the radar transmitting power responds to the vehicle speed. Accordingly, the radar transmitting power can always be monitored whether or not proper radar transmitting power is outputted. Therefore, for example, at step 530, the radar transmitting power is controlled to be the appropriate target value based on the vehicle speed.

In the fourth embodiment, control procedures are exemplified, that is, the radar transmitting power is set to the intermediate transmitting power range B (lower output power transmission) when the vehicle is in the stop condition and is set to the higher transmitting power range C (normal output power transmission) when the vehicle is in the running condition. However, the control procedures are not limited to the above described procedures as long as the radar transmitting power is controlled depending on the vehicle running condition, such that the transmitting power when the vehicle is in running condition, becomes larger compared to the transmitting power when the vehicle is in the stop condition.

### (Modification)

The present invention however is not limited to the embodiment described above, but can be implemented in various modes as provided below.
(1) For instance, unlike the FMCW radar system according to the first embodiment to the fourth embodiment, the present invention can be adapted to a pulse radar system using millimeter-wave radar.

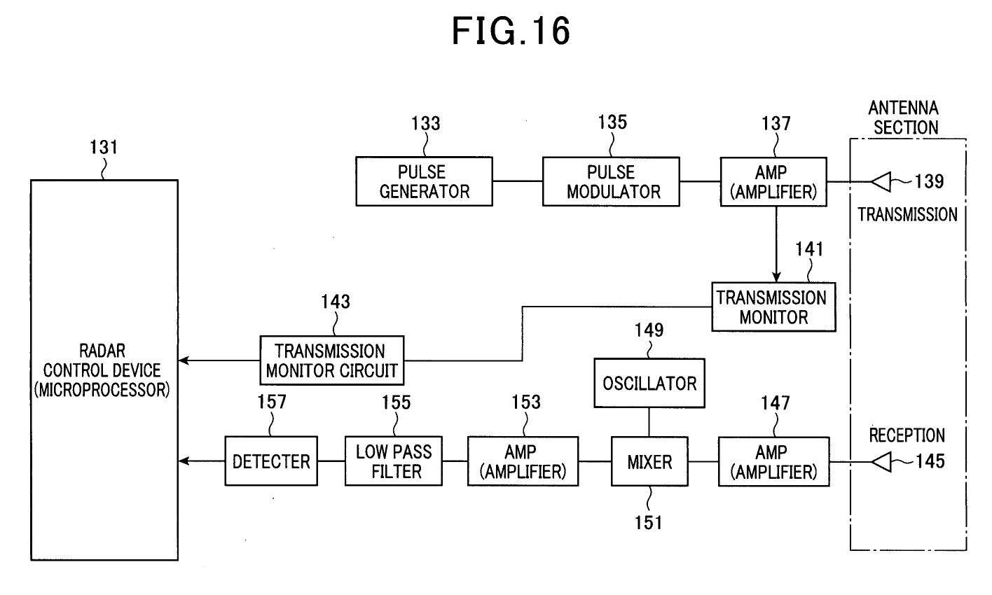

As shown in FIG. 16, the pulse radar system according to the modification includes a radar control device 131 as a control microprocessor. Also, as transmission devices, the pulse radar system includes a pulse generator 133, a pulse modulator 135, an amplifier 137 and a transmission antenna 139. As devices for monitoring the transmission, a transmission monitor 141 and a transmission monitor circuit 143 are included in the pulse radar system. As reception devices, the pulse radar system includes a reception antenna 145, an amplifier 147, an oscillator 149, a mixer 151, a low pass filter 155 and a detector 157.

With this configuration adapted to the pulse radar system, the radar transmitting power is monitored and verified whether or not the transmitting power is within the target range. Therefore, the transmitting power can be feed-back controlled in order change the transmitting power to be in the target range when the transmitting power is out of the target range.
(2) According to the first embodiment to the fourth embodiment, although the transmitting power is classified to three ranges (i.e., a range corresponding to the vehicle-stop condition and two ranges corresponding to the vehicle running conditions), the transmitting power may be classified to two ranges which are the intermediate output range assigned to the vehicle-stop condition and the higher output range assigned to the vehicle running condition. Further, the transmitting power can be classified to ranges to be more precise so that each range has own purpose to be controlled by the radar control device.
(3) Also, the transmitting power may be controlled such that the transmitting power gradually increases when the vehicle speed increases.
(4) In the first embodiment to the fourth embodiment, it is disclosed about the radar apparatus, however, contents of the control procedure applied to the radar apparatus, can be adapted to the computer program that controls the radar apparatus or a recording media that stores the program therein.

The recording media may be various recording media such as an electronic control unit configured as a microprocessor, a microchip, a flexible disk, a hard disk, an optical disk or the like. Accordingly, it is not limited to use any recording media as long as the media is used to store programs adapted to control the above-described radar apparatus.

What is claimed is:

1. A radar apparatus that controls millimeter-wave radar operation, mounted on a vehicle, the radar apparatus comprising:
a vehicle speed detecting means for detecting a vehicle speed;
an output control means for controlling the output power of the radar apparatus; and
an output power setting means for setting the output power of the radar apparatus with at least two different output power levels in response to the vehicle speed; wherein
the output power setting means is configured to drive the output control means to change the output power to be the output power set by the output power setting means.

2. The radar apparatus according to claim 1, further comprising:
a monitoring means for monitoring the output power of the radar apparatus and
a judging means for judging whether or not the output power is within a predetermined target range.

3. The radar apparatus according to claim 2, further comprising a target tracking means for controlling the output power of the radar apparatus to be the predetermined target range when the judging means judges the output power is out of the predetermined target range.

4. The radar apparatus according to claim 2, further comprising a disabling means for disabling the radar apparatus when the judging means judges the output power of the radar apparatus is out of the predetermined target range.

5. The radar apparatus according to claim 1, further comprising a high frequency circuit using a monolithic microwave integrated circuit that has a bias voltage to be controlled, wherein the radar apparatus is configured such that when the radar apparatus starts the operation, the bias voltage of the monolithic microwave integrated circuit is adjusted whereby the output power of the radar apparatus is adjusted.

6. The radar apparatus according to claim 2, further comprising a high frequency circuit using a monolithic microwave integrated circuit that has a bias voltage to be controlled, wherein the radar apparatus is configured such that when the radar apparatus starts the operation, the bias voltage of the monolithic microwave integrated circuit is adjusted whereby the output power of the radar apparatus is adjusted.

7. The radar apparatus according to claim 3, further comprising a high frequency circuit using a monolithic microwave integrated circuit that has a bias voltage to be controlled, wherein the radar apparatus is configured such that when the radar apparatus starts the operation, the bias voltage of the monolithic microwave integrated circuit is adjusted whereby the output power of the radar apparatus is adjusted.

8. The radar apparatus according to claim 4, further comprising a high frequency circuit using a monolithic microwave integrated circuit that has a bias voltage to be controlled, wherein the radar apparatus is configured such that when the radar apparatus starts the operation, the bias voltage of the monolithic microwave integrated circuit is adjusted whereby the output power of the radar apparatus is adjusted.

9. The radar apparatus according to claim 1, wherein the radar apparatus is configured to perform FMCW (Frequency-Modulated Continuous Wave) radar operation, and a modulation period and the number of modulations of the FMCW signal are changed whereby adjusts the output power of the radar apparatus.

10. The radar apparatus according to claim 2, wherein the radar apparatus is configured to perform FMCW (Frequency-Modulated Continuous Wave) radar operation, and a modulation period and the number of modulations of the FMCW signal are changed whereby adjusts the output power of the radar apparatus.

11. The radar apparatus according to claim 3, wherein the radar apparatus is configured to perform FMCW (Frequency-Modulated Continuous Wave) radar operation, and a modulation period and the number of modulations of the FMCW signal are changed whereby adjusts the output power of the radar apparatus.

12. The radar apparatus according to claim 4, wherein the radar apparatus is configured to perform FMCW (Frequency-Modulated Continuous Wave) radar operation, and a modulation period and the number of modulations of the FMCW signal are changed whereby adjusts the output power of the radar apparatus.

13. The radar apparatus according to claim 5, wherein the radar apparatus is configured to perform FMCW (Frequency-Modulated Continuous Wave) radar operation, and a modulation period and the number of modulations of the FMCW signal are changed whereby adjusts the output power of the radar apparatus.

14. The radar apparatus according to claim 9, wherein
the radar apparatus is configured to control a power supply of the monolithic micro integrated circuit ON/OFF in response to the change of the modulation period and/or the change of the number of modulations.
